(19) United States
(12) Patent Application Publication
(10) Pub. No.: US 2011/0304898 A1
(43) Pub. Date: Dec. 15, 2011

(54) ASSEMBLY AND METHOD FOR ADAPTING THE POLARITY OF A POWER SOURCE TO AN ELECTROCHROMIC DEVICE

(76) Inventor: Philippe Letocart, Raeren (BE)

(21) Appl. No.: 13/125,758

(22) PCT Filed: Oct. 26, 2009
(86) PCT No.: PCT/EP09/64059

§ 371 Date: Aug. 26, 2011

(30) Foreign Application Priority Data
Dec. 10, 2008 (DE) 10 2008 061 403.3

(51) Int. Cl. G02F 1/15

(52) U.S. Cl. 359/265

(57) ABSTRACT

An assembly and methods for adapting polarity of a power source to an electrochromic device is described. Moreover, the electrochromic device comprises electrical device connections and circuit arrangements.

The invention is in the technical field of electrochromic devices and relates to an assembly and a method for adapting the polarity of an electrical power source to the polarity of an electrochromic device.

Electrochromic devices, for example, electrochromic glazings, as such are well known and already variously described in the patent literature. Reference is made, merely by way of example, to the European patents EP 0338876, EP 0408427, EP 0628849, and the U.S. Pat. No. 5,985,486. Electrochromic glazings are used, in particular, in buildings and motor vehicles, to steplessly regulate the amount of incident light by a different optical transparency.

In the printed publications DE 197 06 918 A1 or EP 691 12 159 T2, an assembly and method for controlling an electrochromic device is in each case disclosed. In the two methods mentioned, current and/or voltage are measured on the electrochromic element, for which purpose a corresponding measuring device is included in the associated assembly.

As emerges, in particular from the printed publications mentioned, electrochromic glazings include at least one transparent substrate, for example, glass, on which is applied a layer made of an electrically conductive material, and at least one layer made of an electrochromic material, for example, tungsten oxide, that is capable of reversibly storing cations. It is essential here that different oxidation states of the electrochromic material, which correspond to the stored or released state of the cations, have a different coloration, with one of the states usually transparent. By application of electrical voltages of different polarity, the storage or release of cations can be controlled to selectively influence an optical transparency of the electrochromic glazing. Typically, electrochromic devices further include an ion conductive layer, for example, a polymer layer or an inorganic layer (e.g., a ceramic layer made of silicon oxide, tantalum oxide, or hafnium oxide), as well as a counter electrode, for example, a layer made of nickel oxide, iridium oxide, or vanadium oxide.

According to them, electrochromic glazings have, with regard to the polarity of the voltage to be applied, a specific terminal configuration depending on the respective assembly, hereinafter referred to as “polarity”, since only with correspondingly poled voltages can the electrochemical processes for storage or release of cations be effected as desired. Electrochromic glazings must thus be connected to a suitably or properly poled voltage source. Since the maximum admissible voltage for reducing the optical transparency is often higher than that for increasing the optical transparency, it also occurs that with improperly poled voltage sources, damage or premature aging of the electrochromic device is likely if an inadmissibly high voltage is applied. To avoid the problem of connection with an improperly poled voltage source, it is known to provide the connectors of the electrochromic device with mechanical reverse polarity protection, for example, a plug whose coupling is designed such that it can be connected only with a properly poled voltage source. However, it is possible, in practice, for example, with the installation of electrochromic glazings in buildings, for a situation to occur in which a connecting cable with a plug must be lengthened or shortened such that it is necessary to remove the plug. After reinstallation of the plug on the connecting cable, there again exists the risk of connection to an improperly poled voltage source, since improper installation of the plug cannot be ruled out.

In contrast, the object of the present invention consists in providing a capability of reliably and safely avoiding, in everyday practice, an electrical connection of an electrochromic glazing to an improperly poled voltage source.

This and other objects are accomplished according to the proposal of the invention through an assembly and a method for adapting the polarity of an electrical power source to the polarity of an electrochromic device. Advantageous embodiments of the invention are indicated through the characteristics of the subclaims.

According to the invention, an assembly is shown that comprises an electrochromic device, for example, an electrochromic glazing, and a circuit assembly electrically connected to the electrochromic device.

The electrochromic device has two electrical device connections, wherein an optical transparency of the electrochromic device can be reduced or increased by application of electrical voltages and/or electrical currents to the device connections. As already explained in the introduction, the device connections have, with regard to a change of the optical transparency of the electrochromic device, a specific terminal configuration (polarity) for connection to the pole terminals of an electrical power source depending on the respective assembly.

The electrochromic device has an assembly such that it acts as a charge storage means (accumulator) on reduction of the optical transparency (coloration) such that with the presence of reduced optical transparency, an electrical DC voltage generated by the device itself is generated on the two device connections.

The circuit assembly of the assembly according to the invention comprises a voltage/current measurement device connected to the two device connections for measuring an electrical voltage and/or an electrical current between the two device connections.

The circuit assembly further comprises at least one electrical power source (voltage source and/or current source), by which the electrical power (voltage and/or current) can be fed to the electrochromic device. For this, the power source has two pole terminals that are connected to the two device connections with interposition of a controllable pole terminal two-way circuit. The pole terminal two-way circuit enables one device connection to be electrically conductively connected selectively with one of the two pole terminals and, at the same time, the other device connection to be electrically conductively connected with the respective other pole terminal, such that the electrochromic device can be electrically conductively connected with the electrical power source in random poling. Advantageously, the pole terminal two-way circuit also enables an electrical separation of the electrochromic device from the electrical power source.

The circuit assembly further comprises an electronic control circuit for controlling the pole terminal two-way circuit. The control device is configured such that the device connections can be connected in each case with the pole terminals such that the polarity of an electrical voltage measured on the pole terminals and/or an electrical current measured on the pole terminals corresponds to a polarity of the electrical power source. For this, the electronic control device is connected to the voltage/current measurement device and to the pole terminal two-way circuit so as to transmit data.

The assembly according to the invention thus advantageously enables a change of the polarity of an electrical power source that is connected to the device connections of an electrochromic device (having reduced optical transparency) with improper poling such that the optical transparency of the electrochromic device can be controlled as desired and damage due to inadmissibly high electrical voltages can be reliably and safely avoided.

In an advantageous embodiment of the assembly according to the invention, the control device is configured such that when no voltage or current is measurable between the device connections, electrical power (electrical voltage and/or electrical current) is fed to the electrochromic device for a selectable time interval.

Moreover, in this embodiment of the invention, the control device is configured such that:

a) for the case that after expiration of the time interval, an electrical voltage and/or current is measured between the device connections, the device connections are in each case connected to the pole terminals such that a polarity of the electrical variable (voltage and/or current) measured on the pole terminals corresponds to a polarity of the electrical power source, and

b) for the case that after expiration of the time interval, no electrical voltage and/or current is measured between the device connections, the device connections are in each case connected to the pole terminals such that the polarity of the pole terminals is reversed relative to the polarity of the pole terminals during the feeding of the electric power.

This embodiment of the invention thus advantageously enables a change of the polarity of an electrical power source that is connected with improper poling to the device connections of an electrochromic device (having no reduced optical transparency), such that the optical transparency of the electrochromic device is controllable as desired and damage due to inadmissibly high electrical voltages can be reliably and safely avoided.

In another advantageous embodiment of the assembly according to the invention, the voltage/current measurement device is integrated into the electronic control device, enabling a particularly compact circuit assembly.

In a technically simple to realize embodiment of the circuit assembly, the pole terminal two-way circuit comprises a first connection line, by which a first pole terminal of the power source can be electrically conductively connected to a first device connection, as well as a second connection line, by which a second pole terminal of the power source can be electrically conductively connected to a second device connection. The pole terminal two-way circuit further comprises a first transistor pair with a first transistor and a second transistor, wherein a load path of the first transistor divides the first connection line into a first terminal-side section (located on the side of the pole terminal) and a first connector-side section (located on the side of the device connection) and wherein a load path of the second transistor divides the second connection line into a second terminal-side section and a second connector-side section. In addition, the pole terminal two-way circuit comprises a first bridge line, by which the first terminal-side section of the first connection line can be electrically conductively connected to the second connector-side section of the second connection line, as well as a second bridge line, by which the second terminal-side section of the second connection line can be electrically conductively connected to the first connector-side section of the first connection line. The pole terminal two-way circuit further comprises a second transistor pair with a third transistor and a fourth transistor, wherein a load path of the third transistor is contained in the first bridge line and a load path of the fourth transistor is included in the second bridge line.

In the pole terminal two-way circuit, the transistors are wired such that, via the load path of the first transistor, the first pole terminal of the electrical power source can be electrically conductively connected to or separated from the first device connection and, via the load path of the second transistor, the second pole terminal can be electrically conductively connected to or separated from the second device connection. Furthermore, via the load path of the third transistor, die first pole terminal can be electrically conductively connected to or separated from the second device connection; and, via the load path of the fourth transistor, the second pole terminal can be electrically conductively connected to or separated from the first device connection.

In the pole terminal two-way circuit, the control connectors of the transistors are connected to the electronic control device, wherein it can be advantageous if the control connectors of the transistors of one transistor pair are connected to a common signal output of the electronic control device, to thus jointly control a transistor pair.

In another advantageous embodiment of the assembly according to the invention, it comprises a first electrical power source and a second electrical power source, which are, in each case, connected via the pole terminal two-way circuit to the device connections of the electrochromic device, with the pole terminals of the two power sources, controlled by a two-way switch, being selectively connectable to the device connections. Here, the first power source serves to reduce the optical transparency of the electrochromic device whereas the second power source is used to increase the optical transparency of the electrochromic device. It can be particularly advantageous if the two-way switch is connected to the electronic control device so as to transmit data and can be controlled by the control device. In addition, it can be advantageous if a maximum output power (maximum voltage or maximum current) of at least one of the two electrical power sources can be regulated by the electronic control device.

Preferably, the electrochromic device is a (not necessarily glass) electrochromic glazing that is provided with at least one transparent substrate, for example, glass.

The invention further extends to a method for adapting the polarity of an electrical power source to the polarity of an electrochromic device.

In the method according to the invention, an electric voltage and/or an electric current is first measured between device connections of the electrochromic device by means of a voltage/current measurement device. Then, the polarity (sign) of the electrical variable measured (current and/or voltage) is compared by means of an electronic control device with the polarity of the power source, with the device connections connected to the pole terminals such that a polarity of the electrical variable measured (current and/or voltage) corresponds to a polarity of the electrical power source.

The method according to the invention thus, simply and reliably, enables an adaptation of the polarity of the power source to the polarity of an electrochromic device (having a reduced optical transparency).

In an advantageous embodiment of the method according to the invention, for the case that no voltage or current is measurable on the device connections, electrical power (voltage and/or current) is fed to the electrochromic device for a selectable time interval. Furthermore:

a) for the case that after expiration of the time interval, an electrical voltage and/or an electrical current is measured between the device connections, the device connections are in each case connected to the pole terminals such that a polarity of the electrical variable (voltage and/or current) measured on the pole terminals corresponds to a polarity of the electrical power source, and

b) for the case that after expiration of the time interval, no electrical voltage and/or electrical current is measured between the device connections, the device connections are in each case connected to the pole terminals such that the polarity of the pole terminals is reversed relative to the polarity of the pole terminals during feeding of the electric power.

This embodiment enables, in a simple manner, an adaptation of the polarity of the power source to a polarity of the electrochromic device (having no reduced optical transparency). The polarity of the electric power (voltage and/or current) fed can be selected arbitrarily. With a properly poled power source, the optical transparency of the electrochromic device is reduced such that an electrical voltage is generated on the device connections, whereas, in contrast, the optical transparency of the electrochromic device is not reduced with an improperly poled power source and, accordingly, no voltage is generated on the device connections. In both cases, the proper poling of the power source is detected in a simple manner because of the different results.

The invention further extends to a method for operation of an electrochromic device, wherein before a change (in particular, a first-time change) of the optical transparency of the electrochromic device by means of an electrical power source, a method as described above for adapting the polarity of the electrical power source to the polarity of the electrochromic device is executed.

### BRIEF DESCRIPTION OF THE DRAWING

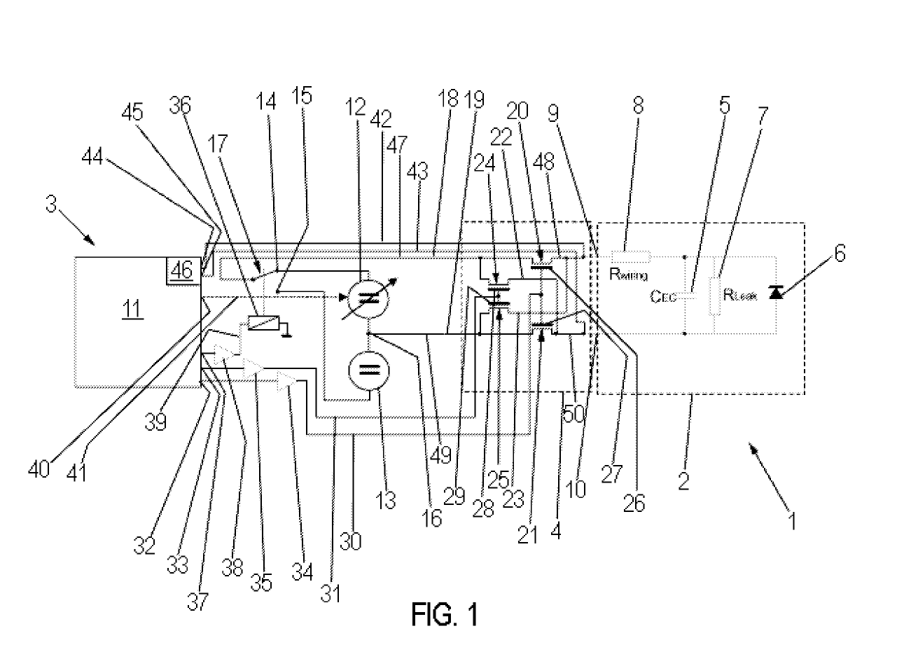

The invention is now explained in greater detail using an exemplary embodiment with reference to FIG. 1, which depicts an assembly according to the invention.

### DETAILED DESCRIPTION OF THE DRAWING

FIG. 1 depicts an assembly designated overall with the reference character 1, which comprises an electrochromic device 2 and a circuit assembly 3 electrically connected to the electrochromic device 2.

The electrochromic device 2 here is, for example, implemented as electrochromic glazing with at least one transparent substrate (e.g., glass window pane). An optical transparency of the electrochromic device 2 can be changed by being subjected to an electrical voltage and/or electrical current of suitable magnitude and polarity, with the electrochromic device 2 acting as a charge storage means with a reduction of the optical transparency.

In the assembly 1 shown in FIG. 1, the electrochromic device 2 is depicted by its equivalent circuit diagram (broken line outline). According to it, the electrochromic device 2 has available, in its character as a charge storage means, one electrical capacitor 5, that can be charged or discharged via the two device connections 9, 10. Depending on the concrete assembly of the electrochromic device 2, the capacitor 5 can be charged only through application of a suitably (properly) poled voltage, which circumstance is depicted in FIG. 1 by a diode 6 connected in parallel to the capacitor 5. For this, the two device connections 9, 10 must be connected to the pole terminals of an electrical power source corresponding to a specific terminal configuration in order to obtain, as desired, coloration (reduction of optical transparency) or decoloration (increase of optical transparency) of the electrochromic device 2. With regard to the charge storing characteristics, coloration of the electrochromic device 2 results in electrical charging of the capacitor 5, whereas decoloration of the electrochromic device 2 results in electrical discharge of the capacitor 5.

A leak resistor 7 connected in parallel to the capacitor 5 denotes a commonly occurring (slight) self-drain of the electrochromic device 2 due to leak currents and creeping currents. A terminal resistor 8 connected in series to the capacitor 5 denotes an electric resistance of the lines to the connection of the capacitor 5 with the device connections 9, 10.

Solely by way of example, it should be indicated that the capacitance of the electrochromic glazing with a contrast of 20 can amount to ca. 300 F/m². The leak resistance 7 can amount to ca. 20 ohm for a glazing with a surface area of 1 m². The terminal resistance 8 can be ca. 0.5 ohm.

The circuit assembly 3 comprises a control device 11 to control various components of the circuit assembly 3. It further comprises a regulatable first electrical power source (voltage/current source) 12 and a non-regulatable second electrical power source (voltage/current source) 13, by which electrical power (electrical DC voltage and/or DC current) can be fed to the electrochromic device 2. The two power sources 12, 13 can be electrically conductively connected alternatingly, with interposition of a pole terminal two-way circuit 4 to the two device connections 9, 10. The two power sources 12, 13 are each provided with two pole terminals, with a like pole terminal of the two power sources 12, 13 short-circuited to a common third pole terminal 16. Thus, the first power source 12 is provided with a first pole terminal 14 and the third pole terminal 16; the second voltage source 13 is provided with a second pole terminal 15 and the third pole terminal 16. The first power source 12 serves to reduce the optical transparency of the electrochromic device 2, while the second power source 13 serves to increase the optical transparency of the electrochromic device 2. The two power sources 12, 13 have, for this, a maximum DC voltage or maximum DC current that is adapted to the respective function, with a maximum DC voltage or maximum DC current of the second power source 13 usually smaller than a maximum DC voltage or maximum DC current of the first power source 12.

Controlled by a two-way switch 17, either the first pole terminal 14 of the first power source 12 or the second pole terminal 15 of the second power source 13 can be electrically connected via a first connection line 18 to the first device connection 9 of the electrochromic device 2. The (common) third pole terminal 16 of the two power sources 12, 13 can be electrically conductively connected via a second connection line 19 to the second device connection 10 of the electrochromic device 2. Both the first connection line 18 and the second connection line 19 are part of the pole terminal two-way circuit 4 that is depicted in FIG. 1 by a broken line outline.

The pole terminal two-way circuit 4 comprises, together with the first connection line 18 and the second connection line 19, a first transistor pair with a first transistor 20 and a second transistor 21 that are in each case implemented as controllable field effect transistors, with each transistor having a load path (i.e., a current path connecting a source and drain connector of the transistor to each other) and a control connection to control the flow of current in the load path. Here, a load path of the first transistor 20 divides the first connection line 18 into a first terminal-side section 47 and a first connector-side section 48, and a load path of the second transistor 21 divides the second connection line 19 into a second terminal-side section 49 and a second connector-side section 50.

The pole terminal two-way circuit 4 further comprises a first bridge line 22, by which the first terminal-side section 47 can be electrically conductively connected to the second connector-side section 50, as well as a second bridge line 23, by which the second terminal-side section 49 can be electrically conductively connected to the first connector-side section 48. In addition, the pole terminal two-way circuit 4 comprises a second transistor pair with a third transistor 24 and a fourth transistor 25 that are each implemented as controllable field effect transistors, with a load path of the third transistor 24 included in the first bridge line 22 and a load path of the fourth transistor 25 included in the second bridge line 23.

A first control connector 26 of the first transistor 20 and a second control connector 27 of the second transistor 21 are connected via a common first control line 30 to a first signal output 32 of the control device 11, such that the control device 11 can, with interposition of a first amplifier 34, transmit control signals for simultaneous control of the two transistors 20, 21 to the first control connector 26 and the second control connector 27. A third control connector 28 of the third transistor 24 and a fourth control connector 29 of the fourth transistor 25 are connected via a common second control line 31 to a second signal output 33 of the control device 11, such that the control device 11 can, with interposition of a second amplifier 35, simultaneously transmit control signals to the third control connector 28 and the fourth control connector 29.

In general, by a corresponding actuation of a control connector of a field effect transistor, an electrical current can pass in the load path controlled by the control connector (optionally with reduced current strength) or be blocked by a field effect.

Because of the interconnection of the two transistor pairs, it can be accomplished by the pole terminal two-way circuit 4 that:

a) the first connection line 18, connected, depending on the position of the two-way switch 17, to the first pole terminal 14 or the second pole terminal 15, is electrically conductively connected to the first device connection 9, and, at the same time, the second connection line 19, connected to the third pole terminal 16, is electrically conductively connected to the second device connection 10, when the first transistor 20 and the second transistor 21 are each switched to passage and the third transistor 24 and the fourth transistor 25 are each blocked; or

b) the first connection line 18, connected, depending on the position of the two-way switch 17, to the first pole terminal 14 or the second pole terminal 15, is electrically conductively connected to the second device connection 10, and, at the same time, the second connection line 19, connected to the third pole terminal 16, is electrically conductively connected to the first device connection 9, when the first transistor 20 and the second transistor 21 are each blocked and the third transistor 24 and the fourth transistor 25 are each switched to passage; or

c) the first connection line 18 and/or the second connection line 19 of the two device connections 9, 10 are electrically separated, when the first transistor 20 and the third transistor 24 and/or the second transistor 21 and the fourth transistor 25 are each blocked, for example, to measure a DC voltage and/or a DC current on the device connections 9, 10.

The two-way switch 14 for the connection of the first power source 12 or the second power source 13 to the pole terminal two-way circuit 4 can, controlled by the control device 11, be actuated by a grounded actuator 36 (for example, an electromagnet), that is connected via a third control line 39, with interposition of a third amplifier 38, to a third signal output 37 of the control device 11.

The regulatable first power source 12 is connected via a fourth control line 41 to a fourth signal output (A/D output) 40 of the control device 11 so as to transmit data. The control device 11 can generate and deliver control signals to the fourth signal output 40, which control signals are transmitted via the fourth control line 41 to the first power source 12, to regulate a maximum voltage or maximum current. Through the magnitude of the maximum voltage or maximum current, the optical transparency of the electrochromic device 2 can be reduced to a desired transparency value.

The control device 11 is further provided with an integrated voltage/current measurement device 46, which is electrically conductively connected to the two device connections 9, 10 of the electrochromic device 2 via a first signal input 44 (A/D input) and a first measurement line 42 connected thereto, as well as via a second signal input 45 (A/D input) and a second measurement line 43 connected thereto. The voltage/current measurement device 46 can measure an electrical DC voltage and/or an electrical DC current (including sign) between the two device connections 9, 10.

The electronic control device 11 is configured, for example, as a programmable logic controller (microprocessor), in which a machine-readable program code can be executed or is executed, which is provided with instructions by which the controllable components of the assembly 1 are controlled as desired. In addition, the electronic control device 11 stores which electrical pole (plus or minus pole) the first pole terminal 14, the second pole terminal 15, or the third pole terminal 16 of the two power sources 12, 13 correspond to, such that the control device 11, depending on the position of the two-way switch 14, by means of the pole terminal two-way circuit 4 can electrically conductively connect,
selectively, the first device connection 9 to the plus or minus pole of the first power source 12 and, at the same time, the second device connection 10 to the respective other pole of the first power source 12 or
selectively, the first device connection 9 to the plus or minus pole of the second power source 13 and the second device connection 10 to the respective other pole of the second power source 13.

In the electronic control device 11, machine readable program code is implemented, by which, in particular before the first-time electrical connection of the electrochromic device 2 with the first power source 12, an electrical DC voltage (including its sign) is measured on the two device connections 9, 10 by means of the voltage/current measurement device 46. A measurement of the electrical voltage or of the electrical current occurs when no electrical power is fed to the electrochromic device 2.

For the case that the two-way switch 14 is switched such that the first power source 12 is connected to the electrochromic device 2, this can be accomplished through the fact that that the transistors are blocked.

Initially, a first variant is considered in which the electrochromic device 2 has a reduced optical transparency such that an electrical DC voltage can be measured on the two device connections 9, 10 because of their character as charge storage means.

After measurement of the DC voltage and/or DC current occurring on the two device connections 9, 10, the sign (polarity) of the electrical variable measured is compared with the polarity of the first power source 12, and the first power source 12 is electrically conductively connected to the device connections 9, 10 such that the polarity of the first power source 12 is the same as the polarity of the electrical variable measured. If, for example, a positive DC voltage is measured on the device connections 9, 10, whereby the first device connection 9 has a higher potential than the second device connection 10, and if the first pole terminal 14 has a higher potential than the third pole terminal 15, the first pole terminal 14 is electrically conductively connected to the first device connection 9 and the third pole terminal 16 is electrically conductively connected to the second device connection 10. For this, in the circuit assembly 3, the first transistor pair with the first transistor 20 and the second transistor 21 is switched to passage, whereas the second transistor pair with the third transistor 24 and the fourth transistor 25 is blocked. If, on the other hand, a negative DC voltage is measured on the device connections 9, 10, whereby the first device connection 9 has a lower potential than the second device connection 10, and if the first pole terminal 14 has a higher potential than the third pole terminal 15, the third pole terminal 16 is electrically conductively connected to the first device connection 9 and the first pole terminal 14 is electrically conductively connected to the second device connection 10. For this, in the circuit assembly 3, the first transistor pair with the first transistor 20 and second transistor 21 is blocked, whereas the second transistor pair with the third transistor 24 and the fourth transistor 25 is switched to passage.

Now, a second variant is considered in which the electrochromic device 2 has no reduced optical transparency such that no electrical DC voltage is generated on the two device connections 9, 10.

In this case, the first power source 12, regardless of the polarity of its pole terminals 14, 16, is electrically conductively connected for a selectable time interval to the two device connections 9, 10 (hereinafter referred to for easier reference as “charging step”). The magnitude of the DC voltage or DC current applied during the charging step to the two device connections is selected such that a maximum admissible DC voltage or DC current of the electrochromic device 2 is not exceeded.

Then, the first power source 12 is again separated from the electrochromic device 2, which can be accomplished by blocking the transistors.

If an electrical DC voltage or a DC current is now measured on the two device connections 9, 10, the sign (polarity) of the electrical variable measured is compared with the polarity of the first power source 12 and the first power source 12 is electrically conductively connected to the device connections 9, 10 such that the polarity of the first power source 12 is the same as the polarity of the electrical variable measured. This can occur in the manner already described above in connection with the first variant. In order to avoid unnecessary repetitions, reference is made to the statements there. Here, the polarity of the two pole terminals 14, 16 of the first power source 12 corresponds to the polarity during the charging step since only then can a reduction of the optical transparency of the electrochromic device 2 be obtained.

If, furthermore, no electrical DC voltage or no electrical current is measured on the two device connections 9, 10, the pole terminals 14, 16 of the first power source 12 are electrically conductively connected to the device connections 9, 10 such that their polarity is opposite the polarity of the pole terminals 14, 16 during the charging step. If, during the charging step, for example, the first device connection 9 was electrically conductively connected to the first pole terminal 14 and the second device connection 10 with the third pole terminal 16, the first device connection 9 is now electrically conductively connected to the third pole terminal 16 and the second device connection 10 to the first pole terminal 14. For this, in the circuit assembly 3, the first transistor pair with the first transistor 20 and the second transistor 21 is blocked, whereas the second transistor pair with the third transistor 24 and the fourth transistor 25 is switched to passage. If, on the other hand, during the charging step, the first device connection 9 was electrically conductively connected to the third pole terminal 16 and the second device connection 10 to the first pole terminal 4, the first device connection 9 is now electrically conductively connected to the first pole terminal 14 and the second device connection 10 to the third pole terminal 16. For this, in the circuit assembly 3, the first transistor pair with the first transistor 20 and the second transistor 21 is switched to passage, whereas the second transistor pair with the third transistor 24 and the fourth transistor 25 is blocked.

If the pole terminals of the first power source 12 are connected in proper poling to the electrochromic device 2, the optical transparency of the electrochromic device 2 can be reduced as desired, controlled by the control device 11. By reversing the two-way switch 14 and connection to the second power source 13, the optical transparency of the electrochromic device 2 can be increased.

The assembly according to the invention 1 thus advantageously enables an adaptation of the polarity of the first power source 12 used to reduce the optical transparency or the second power source 13 used to increase the optical transparency to the polarity of the electrochromic device 2. In this manner, a desired control of the optical transparency of the electrochromic device 2 can be ensured and damage due to erroneous subjection to excessive DC voltage or to excessive DC current can be reliably avoided.

Although in the exemplary embodiment explained in connection with FIG. 1, two power sources 12, 13 are used, with the first power source 12 serving to reduce the optical transparency and the second power source 13 serving to increase the optical transparency, it would be equally conceivable to provide only a single power source, for example, the first power source 12, and obtain an increase of the optical transparency of the electrochromic device 2 by short-circuiting the two device connections 9, 10. This can, for example, be accomplished by switching all four transistors to passage, whereby, for example, an additional controllable transistor would have to be provided in the second connection line 19. Equally conceivable, alternatively, would be, for increasing the optical transparency of the electrochromic device 2, to reverse the polarity of the pole terminals 14, 16 electrically conductively connected to the two device connections 9, 10 by means of the pole terminal two-way circuit 4, whereby, in this case, if need be, the maximum output power would have to be reduced in order to avoid damaging the electrochromic device 2.

### LIST OF REFERENCE CHARACTERS

1 assembly

2 electrochromic device

3 circuit assembly

4 pole terminal two-way circuit

5 capacitor

6 diode

7 leak resistor

8 terminal resistor

9 first device connection

10 second device connection

11 control device

12 first power source

13 second power source

14 first pole terminal

15 second pole terminal

16 third pole terminal

17 two-way switch

18 first connection line

19 second connection line

20 first transistor

21 second transistor

22 first bridge line

23 second bridge line

24 third transistor

25 fourth transistor

26 first control connector

27 second control connector

28 third control connector

29 fourth control connector

30 first control line

31 second control line

32 first signal output

33 second signal output

34 first amplifier

35 second amplifier?

36 actuator

37 third signal output

38 third amplifier

39 third control line

40 fourth signal output

41 fourth control line

42 first measurement line

43 second measurement line

44 first signal input

45 second signal input

46 voltage/current measurement device

47 first terminal-side section

48 first connector-side section

49 second terminal-side section

50 second connector-side section

1. An assembly comprising: an electrochromic device with a first electrical device connection, a second electrical device connection and a circuit arrangement the circuit arrangement further comprising:
a voltage/current measurement device connected to the first electrical device connection and the second electrical device connection;
at least one electrical power source with a first pole terminal and a second pole terminal, the at least one electrical power source connected to the first electrical device connections and the second electrical device connection via a controllable pole terminal two-way circuit, wherein the first electrical device connection adapted to be electrically conductively connected by the pole terminal two-way circuit selectively to the first pole terminal, and the second electrical device connection connectable to the second pole terminal, respectively; and
an electronic control device for controlling the pole terminal two-way circuit, the electronic control device being configured to measure electrical voltage and/or electrical current between the first electrical device connection and the second electrical device connections, the first electrical device connection and the second electrical device connection being connected to the first pole terminals and the second pole terminal such that a polarity of an electrical variable measured on the first electrical device connection and the second electrical device connection correspond to the polarity of the electrical power source.

2. The assembly according to claim 1, wherein the electronic control device is configured to feed electrical power to the electrochromic device for a selectable time interval and no voltage is measurable between the first electrical device connection and the second electrical device connection, such that after expiration of the selectable time interval:
if an electrical voltage and/or an electrical current is measured between the first electrical device connection and the second electrical device connection, the first electrical device connection and the second electrical device connection are connected to the first pole terminal and the second pole terminal such that the polarity of the electrical variable measured on the first electrical device connections and the second electrical device connection corresponds to the polarity of the electrical power source, and
if no electrical voltage or electrical current is measured between the first device connection and the second device connection, the first electrical device connection and the second electrical device connection are connected to the first pole terminal and the second pole terminal such that the polarity of the first pole terminal and the second pole terminal are reverse relative to the polarity of the first pole terminal and the second pole terminal during feeding of the electrical power.

3. The assembly according to claim 1, wherein the voltage/current measurement device is integrated into the electronic control device.

4. The assembly according to claim 1, wherein the pole terminal two-way circuit further comprises:
a first connection line by which the first pole terminal of the electrical power source is adapted to be electrically conductively connected to the first electrical device connection;
a second connection line by which the second pole terminal of the electrical power source is adapted to be electrically conductively connected to the second device connection;
a first transistor pair comprising a first transistor and a second transistor with a load path of the first transistor dividing the first connection line into a first terminal-side section and a first connector-side section, and a load path of the second transistor dividing the second connection line into a second terminal-side section and a second connector-side section;
a first bridge line by which the first terminal-side section is adapted to be electrically conductively connected to the second connector-side section;
a second bridge line by which the second terminal-side section is adapted to be electrically conductively connected to the first connector-side section; and
a second transistor pair comprising a third transistor and a fourth transistor with a load path of the third transistor included in the first bridge line, and a load path of the fourth transistor included in the second bridge line,
wherein control connectors of the first pair of transistors and the second pair of transistors are connected to the electronic control device.

5. The assembly according to claim 4, wherein the control connectors of one respective pair of transistors from the first pair transistors or the second pair of transistors are connected to a common signal output of the electronic control device.

6. The assembly according to claim 1, further comprising a first electrical power source and a second electrical power source each connected via the pole terminal two-way circuit to the first electrical device connections and the second electrical device connection, wherein the pole terminals of the two power sources are selectively connectable and controllable by a two-way switch to the first electrical device connections and the second electrical device connection.

7. The assembly according to claim 6, wherein the two-way switch is adapted to be controlled by the electronic control device.

8. The assembly according to claim 6, wherein a maximum output voltage or a maximum output current of at least one of the first electrical power source or the second electrical power source is adapted to be regulated by the electronic control device.

9. The assembly according to claim 1, wherein the electrochromic device is an electrochromic glazing, further comprising at least one transparent substrate.

10. A method for adapting a polarity of an electrical power source to the polarity of an eletrochromic device, the method comprising:
measuring an electric voltage or an electric current between device connections of the electrochromic device by means of a voltage/current measuring device;
comparing the polarity of an electrical variable measured to the polarity of the electrical power source by means of an electronic control device; and
making an electrical connection of the device connections to pole terminals by means of a pole terminal two-way circuit controlled by a control device, the device connections being connected to the pole terminals such that the polarity of the electrical variable measured on the pole terminals corresponds to the polarity of the electrical power source.

11. The method according to claim 10, wherein electrical power is fed to the electrochromic device for a selectable time interval and no electrical voltage or electrical current is adapted to be measured between the device connections, such that after expiration of the selectable time interval:
if an electrical voltage or an electrical current is measured between the device connections, the device connections are connected to the pole terminals such that the polarity of the voltage measured on the pole terminals corresponds to the polarity of the electrical power source, and
if no electrical voltage or electrical current is measured between the device connections, the device connections are connected to the pole terminals such that the polarity of the pole terminals are reversed relative to the polarity of the pole terminals during feeding of the electrical power.

12. A method for operation of an electrochromic device, wherein before a change of an optical transparency of the electrochromic device by means of an electrical power source, performing the method according to claim 10 for adapting the polarity of the electrical power source to the polarity of the electrochromic device.
